(19) United States
(12) Patent Application Publication
(10) Pub. No.: US 2011/0215748 A1
(43) Pub. Date: Sep. 8, 2011

(54) ELECTRIC ACTUATOR AND MODULE FOR SUPPLYING POWER DURING A POWER FAILURE

(75) Inventors: Makoto Saruwatari, Tokyo (JP); Hiroaki Narita, Tokyo (JP)

(73) Assignee: Yamatake Corporation, Tokyo (JP)

(21) Appl. No.: 12/968,491

(22) Filed: Dec. 15, 2010

(30) Foreign Application Priority Data
Mar. 5, 2010 (JP) 2010-048767
Mar. 5, 2010 (JP) 2010-048773
Mar. 5, 2010 (JP) 2010-048775
Mar. 5, 2010 (JP) 2010-048777

(51) Int. Cl. H02P 1/18

(52) U.S. Cl. 318/453

(57) ABSTRACT

An electric actuator is provided having the same configuration whether used as an ordinary electric actuator or as an electric actuator having an emergency shutoff function. A portion for supplying power during a power failure, a power failure detection circuit, and a motor power supply switching circuit are provided in a module detachably coupled to the electric actuator. When failure of primary power is not detected, the power is sent to the electric actuator by the motor power supply switching circuit. When failure of the primary power is detected, secondary power is sent to the electric actuator by the motor power supply switching circuit. In addition, notification of the power failure is sent from the module to the control board of the electric actuator, via a relay connector. After being notified of the power failure, the control board reads a specified aperture during a power failure from a memory, and drives the motor with secondary power from the module as the energy source, thereby setting the aperture of the valve to the aperture during a power failure.

### CROSS-REFERENCE TO RELATED APPLICATION

This application is being filed concurrently with co-pending U.S. patent application Ser. No. ______ (attorney docket number 96859/8) and U.S. patent application Ser. No. ______ (attorney docket number 96859/11), the contents of which are fully incorporated herein by reference.

### FIELD OF THE INVENTION

The present invention relates to a module for supplying power during a power failure that is used after being connected to an electric actuator that controls a flow by adjusting the aperture of a control target such as a valve, damper, etc.

### BACKGROUND OF THE INVENTION

Conventionally, to adjust the aperture of a control target, an electric actuator is used in air-conditioning equipment, targeting the control of the damper, etc., that adjusts the volume of conditioned air supplied to an air-conditioned area, via valves and ducts provided in cold- and hot-water piping thereof.

This type of ordinary electric actuator controls operation by providing an alternating current (“AC”) motor as the drive motor within the electric actuator to supply AC power as the operating power supply, and by matching the actual aperture of the control target to the set aperture, in accordance with control instructions from the air-conditioning controller. In such an electric actuator operated by such an AC power supply, when the supplied AC power fails, the aperture-controlled control target remains at the operating aperture immediately before power failure, and the appropriate aperture control can no longer be performed.

Therefore, an electric actuator of the following type has also been proposed and already exists: when the AC power supplied to the electric actuator fails, it is forcibly operated to the predetermined aperture (e.g., fully closed), and until the AC power supply returns to the conductive state, the predetermined aperture thereof is maintained. Hereinafter, this type of electric actuator is called an electric actuator having an emergency shutoff function.

As of now, two specific types have been proposed as an electric actuator having an emergency shutoff function: one type is called the spring return type, and the other type is called the secondary power supply drive type.

(Spring Return-Type Electric Actuator)

In the spring return-type electric actuator, a return spring biased so as to maintain the fully closed state relative to the drive shaft of the electric actuator is mounted, and when AC power is supplied, the aperture of the control target is adjusted by driving the drive motor against the biasing force of this return spring; and when the power fails, the aperture of the control target is forcibly set to the predetermined aperture by the biasing force of the return spring. An example of a spring return-type electric actuator can be found in Japanese Unexamined Patent Publication No. 2002-174269.

(Secondary Power Supply Drive-Type Electric Actuator)

On the other hand, in the secondary power supply drive-type electric actuator, the drive motor of the electric actuator is a direct current (“DC”) motor; it is separately equipped with a secondary power supply (DC power supply) that comprises a secondary battery, an electric double-layer capacitor, etc.; when AC power is supplied, the aperture of the control target is adjusted by converting this AC power to DC and driving the DC motor; when the power fails, the secondary power supply becomes the operating power supply; and the DC motor is driven by the secondary power supply (DC power supply), thereby forcibly setting the aperture of the control target to the predetermined aperture. An example of the secondary power supply drive-type electric actuator can be found in Japanese Unexamined Patent Publication No. 2008-89109.

However, when these two types of electric actuators having an emergency shutoff function are compared, the spring return-type electric actuator functions as a resistance to the motor drive when the biasing force of the return spring is normal. Therefore, to overcome this resistance, a high-torque motor must be used as the drive motor, which has the disadvantage of increasing the size, weight, and cost of the electric actuator.

In contrast, the secondary power supply drive-type electric actuator lacks the disadvantages of the spring-return type, and is becoming advantageous because of, among other things, recent improvement in the capacitance of the electric double-layer capacitor and the secondary battery, which is the secondary power supply.

In the conventional electric actuator, however, there is considerable structural difference between an electric actuator having an emergency shutoff function and an electric actuator lacking an emergency shutoff function (the ordinary electric actuator), so two types of electric actuators must be produced.

In addition, when a user who has been using the ordinary electric actuator wants later to have the emergency shutoff function in the electric actuator, it is necessary either to considerably remodel the existing electric actuator or to separately purchase an electric actuator having an emergency shutoff function and substitute it for the existing electric actuator, which entails cost or time-consuming remodeling and substitution.

When the ordinary electric actuator is remodeled into a secondary power supply drive-type electric actuator, for example, an AC motor is used as the motor that drives the ordinary electric actuator, so it becomes necessary to substitute a DC motor for this AC motor, replace the control board, add a module having an emergency shutoff function, etc. It also is necessary to dispose of the replaced parts. Thus, when an ordinary electric actuator is remodeled into a secondary power supply drive-type electric actuator, the cost and time required for remodeling become excessive.

### SUMMARY OF THE INVENTION

The present invention was developed to solve the above problems, and it aims at providing a module for supplying power during a power failure, that is capable of using an electric actuator having the same configuration, as both the ordinary electric actuator and as an electric actuator having an emergency shutoff function.

To attain such an objective, in a module for supplying power during a power failure that is detachably connected via a cable to an electric actuator that comprises an AC motor, an actual aperture detection means that detects the actual aperture of a control target driven by this AC motor, a control means that generates a control output that matches to the set aperture the actual aperture detected by this actual aperture detection means, a drive output signal generation means that receives the control output generated by this control means and generates a drive output signal to the AC motor, and an AC power supply input portion that is the energy source of the drive output signal generated by this drive output signal generation means, the present invention comprises an AC power supply relay means that relays AC power to the electric actuator, a power failure detection means that detects failure of the AC power to the electric actuator, a means of supplying power during a power failure that, instead of the AC power supply, acts as the energy source when the power fails, and a power supply selection means that selects the AC power supply relayed by the AC power supply relay means as the AC power supplied to the electric actuator when the power failure detection means does not detect failure of the AC power, that selects the power supply during a power failure, from the means of supplying power during a power failure, as the AC power supplied to the electric actuator when the power failure detection means detects failure of the AC power, with the following inputs: the AC power relayed by the AC power relay means, and the power supplied during a power failure from the means of supplying power during a power failure.

When the present invention's module for supplying power during a power failure is not connected to the electric actuator, this electric actuator operates after being supplied with AC power from the input portion, and control is performed to match the actual aperture of the control target to the set aperture. As a result, this electric actuator functions as an ordinary electric actuator.

When the present invention's module for supplying power during a power failure is connected to the electric actuator, the presence/absence of failure of the AC power to the electric actuator is detected in the module for supplying power during a power failure. If power failure is not detected, the AC power relayed by the AC power relay means is supplied to the electric actuator. If power failure is detected, the power during a power failure from the means of supplying power during a power failure is supplied to the electric actuator.

As a result, where a power failure does not occur, the electric actuator operates after being supplied with AC power from the module for supplying power during a power failure, and control is performed to match the actual aperture of the control target to the set aperture. Where a power failure occurs, the electric actuator operates after being supplied with the power supplied during a power failure from the module for supplying power during a power failure. During the supply of this power supplied during a power failure, if control is performed so as to cause the actual aperture of the control target to reach the set aperture (e.g., fully closed) in the electric actuator, the electric actuator functions as an electric actuator having an emergency shutoff function.

According to the module for supplying power during a power failure of the present invention, when it is not connected to the electric actuator, this electric actuator can be made to function as an ordinary electric actuator; when it is connected to the electric actuator, this electric actuator can be made to function as an electric actuator having an emergency shutoff function; and depending on whether or not the module for supplying power during a power failure is connected, an electric actuator having the same configuration can be used either as an ordinary electric actuator or an electric actuator having an emergency shutoff function.

In exemplary embodiments, the systems and methods can include an electric actuator having a rotatable shaft responsive to a first signal and a memory that stores a specified position for the rotatable shaft when primary power is removed from the electric actuator. The electric actuator receives a second signal generated outside the electric actuator to indicate whether the primary power is removed.

In exemplary embodiments, the systems and methods can include the electric actuator, wherein, when the second signal indicates that the primary power is removed from the electric actuator, the first signal is based at least in part on the specified position for the rotatable shaft that is stored in the memory. The electric actuator can further comprise a motor coupled to the rotatable shaft, where the motor is responsive to the first signal to adjust a position of the rotatable shaft to the specified position that is stored in the memory.

In exemplary embodiments, the systems and methods can include the electric actuator being configured to receive secondary power externally.

In exemplary embodiments, the systems and methods can include the electric actuator, wherein the primary power and the secondary power are of the same type. Each of the primary power and the secondary power are alternating current power.

In exemplary embodiments, the systems and methods can include the electric actuator comprising a device coupled to the rotatable shaft where the device detects a position of the rotatable shaft. Additionally, the device can generate a position signal indicating the position of the rotatable shaft. Furthermore, the first signal is generated based at least in part on the position signal. Additionally, the device can comprise a potentiometer. Still further, the device can generate an arrival signal indicating that the rotatable shaft has arrived at a predetermined position. Additionally, the first signal is generated based at least in part on the arrival signal. Furthermore, the device can comprise a limit switch.

In exemplary embodiments, the systems and methods can include an electric actuator comprising a rotatable shaft that is responsive to a first signal, wherein the electric actuator receives a second signal that is generated outside of the electric actuator and specifies a position for the rotatable shaft when primary power is removed from the electric actuator.

In exemplary embodiments, the systems and methods can include the electric actuator wherein, when the primary power is removed from the electric actuator, the first signal is generated based at least in part on the second signal. Additionally, the electric actuator can further comprise a motor coupled to the rotatable shaft. The motor can be responsive to the first signal to adjust the position of the rotatable shaft to the position that is specified by the second signal. The electric actuator can be configured to receive secondary power externally. Further, the primary power and the secondary power can be of the same type. Additionally, each of the primary power and the secondary power source can be alternating current power.

In exemplary embodiments, the systems and methods can include the electric actuator further comprising a device coupled to the rotatable shaft, where the device detects a position of the rotatable shaft. The device can generate a position signal indicating the position of the rotatable shaft. Additionally, the first signal can be generated based at least in part on the position signal. Furthermore, the device can comprise a potentiometer. Further still, the device can generate an arrival signal that indicates that the rotatable shaft has arrived a predetermined position. Additionally, the first signal can be generated at least in part on the arrival signal. Further, the device can comprise a limit switch.

In exemplary embodiments, the systems and methods can include a module for supplying power to an electric actuator comprising a detection circuit generating a signal indicating whether primary power is being supplied to the module. The module can also comprise a power supply storing primary power supplied to the electric actuator. The power supply provides secondary power of a similar type as the primary power. The module can further comprise a switching circuit outputting, in response to the signal, one of the primary power or the secondary power.

In exemplary embodiments, the systems and methods can include the module wherein the module is configured to provide the output of the switching circuit external to the module.

In exemplary embodiments, the systems and methods can include the module, wherein the module is configured to provide the signal external to the module.

In exemplary embodiments, the systems and methods can include the module, wherein each of the primary power and the secondary power are alternating current power.

In exemplary embodiments, the systems and methods can include a module for supplying power to an electric actuator comprising a detection circuit generating a first signal indicating whether primary power is being supplied to the module. The module can also comprise a power supply storing primary power supplied to the electric actuator. The power supply provides secondary power of a similar type as the primary power. The module can further comprise a switching circuit outputting, in response to the first signal, one of the primary power or the secondary power. The module generates, in response to the first signal, a second signal that specifies an output for the electric actuator when primary power is removed from the electric actuator.

In exemplary embodiments, the systems and methods can include the module, wherein the module is configured to provide the output of the switching circuit external to the module. The module can be configured to provide the second signal external to the module.

In exemplary embodiments, the systems and methods can include the module, wherein each of the primary power and the secondary power are alternating current power.

In exemplary embodiments, the systems and methods can include an electric actuator system, comprising an electric actuator and a module detachably connected to the electric actuator. The electric actuator comprises a rotatable shaft responsive to a first signal that is generated based at least in part on a second signal received from outside the electric actuator.

In exemplary embodiments, the systems and methods can include the electric actuator, wherein the second signal indicates whether primary power is being supplied to the module. The module can further comprise a detection circuit generating the second signal. The module can also further comprise a power supply storing primary power supplied to the electric actuator. The power supply provides secondary power of a similar type as the primary power when the primary power is removed from the module. The module can also comprise a switching circuit outputting, in response to the second signal, one of the primary power or the secondary power.

In exemplary embodiments, the systems and methods can include the electric actuator, wherein the second signal specifies a position of the rotatable shaft when primary power is removed from the electric actuator. The module can also comprise a detection circuit generating a third signal indicating whether primary power is being supplied to the module. The module can further comprise a power supply storing primary power supplied to the electric actuator. The power supply can provide secondary power of the similar type as the primary power. The module can also comprise a switching circuit outputting one of the primary power or the secondary power in response to the third signal.

In exemplary embodiments, the systems and methods can include the electric actuator, wherein the second signal is generated in response to the third signal.

In exemplary embodiments, the systems and methods can include the electric actuator, wherein the electric actuator further comprises a device coupled to the rotatable shaft, the device detecting a position of the rotatable shaft. Additionally, the device can generate a position signal indicating the position of the rotatable shaft. Furthermore, the first signal can be generated based at least in part on the position signal.

In exemplary embodiments, the systems and methods can include the electric actuator, wherein the device generates an arrival signal indicating that the rotatable shaft has arrived at a predetermined position. The first signal can be generated based at least in part on the arrival signal.

In exemplary embodiments, a method for providing an electric actuator with a shutoff function can comprise the steps of deriving secondary power for the electric actuator from primary power for the electric actuator, the secondary power is of a similar type as the primary power; detecting whether primary power is available to the electric actuator, the detecting step is performed external to the electric actuator; providing the primary power to the electric actuator when the detecting step indicates that primary power is available to the electric actuator; and providing the secondary power to the electric actuator when the detecting step indicates that primary power is not available to the electric actuator.

In exemplary embodiments, each of the primary power and the secondary power can be alternating current power. The deriving step can comprise the steps of converting the primary power from alternating current power to direct current power; storing the direct current power; and converting the direct current power to alternating current power.

In exemplary embodiments, the method for providing an electric actuator with a shutoff function comprises the steps of generating a first signal external to the actuator; supplying the first signal to the electric actuator; and generating a second signal internal to the electric actuator based at least in part on the first signal. The first signal can indicate whether primary power is available to the electric actuator. The electric actuator can comprise a rotatable shaft; and the method can further comprise the steps of providing the electric actuator with a memory; storing in the memory a specified position for the rotatable shaft when primary power is not available to the electric actuator; and generating the second signal in such a way that the position of the rotatable shaft is adjusted to the specified position. The method can further comprise the step of determining when the rotatable shaft has reached the specified position.

In exemplary embodiments, the first signal can specify a position of the rotatable shaft when primary power is not available to the electric actuator. The method can further comprise the step of determining when the rotatable shaft has reached the specified position.

In exemplary embodiments, the systems and methods can include a module for supplying power during a power failure that is detachably connected via a cable to an electric actuator that comprises an AC motor, an actual aperture detection means that detects the actual aperture of a control target driven by the AC motor, a control means that generates a control output that matches to the set aperture the actual aperture detected by the actual aperture detection means, a drive output generation means that receives the control output generated by the control means and generates a drive output to the AC motor, and an AC power supply input portion that is the energy source of the drive output generated by the drive output generation means. The module further comprises an AC power supply relay means that relays AC power to the electric actuator, a power failure detection means that detects failure of the AC power to the electric actuator, a means of supplying power during a power failure that, instead of the AC power supply, acts as the energy source when the power fails, and a power supply selection supply means that selects the AC power supply relayed by the AC power supply relay means as the AC power supplied to the electric actuator when the power failure detection means does not detect failure of the AC power, that selects the power supply when power fails, from the means of supplying power during a power failure, as the AC power supplied to the electric actuator when the power failure detection means detects failure of the AC power, with the following inputs: the AC power relayed by the AC power relay means, and the power supply during a power failure from the means of supplying power during a power failure.

In exemplary embodiments, the systems and methods can include the module supplying power during a power failure, wherein the means of supplying power during a power failure outputs to the power supply selection supply means the power supply during a power failure, which was created by converting the DC power supply to AC power.

In exemplary embodiments, the systems and methods can include the module for supplying power during a power failure, wherein the means of supplying power during a power failure comprises an AC/DC power supply conversion means that converts to DC power the branching input, with the AC power supply relayed by AC power supply relay means as the branching input; a storage means that stores the charge obtained from the DC power supply converted by the AC/DC power supply conversion means; and a DC/AC power supply conversion means that generates a power supply that was converted to AC by using the charge stored in the storage means, and outputs it to the power supply selection supply means as the power supply during a power failure.

In exemplary embodiments, the systems and methods can include the module for supplying power during a power failure, wherein the power failure detection means notifies of the presence/absence of detection of the failure of power to the electric actuator.

In exemplary embodiments, the systems and methods can include the module for supplying power during a power failure, wherein it comprises a power failure aperture notification means that notifies the electric actuator of the predetermined aperture to be maintain when power to the control target fails, as the aperture during a power failure.

### BRIEF DESCRIPTION OF THE DRAWINGS

Exemplary embodiments of this invention will be described with reference to the accompanying figures.

FIG. 1 is a block diagram showing the main portion of the electric actuator, before connection of the module for supplying power during a power failure of the present invention.

FIG. 2 is a diagram showing the appearance of this electric actuator.

FIG. 3 is a diagram showing the state in which a first embodiment of the module for supplying power during a power failure of the present invention is connected to this electric actuator.

FIG. 4 is a block diagram of the main portion after connection of the module for supplying power during a power failure, to this electric actuator.

FIG. 5 is a diagram showing the configuration of the interior of the module for supplying power during a power failure.

FIG. 6 is a diagram showing an example in a second embodiment such that the power failure aperture signal is sent to the electric actuator, from the module for supplying power during a power failure.

FIG. 7 is a diagram showing an example such that, in the first embodiment, a class D amplifier and a power supply filter are used to configure the DC/AC power conversion portion in the portion for supplying power during a power failure.

FIG. 8 is a diagram showing an example such that, in the second embodiment, a class D amplifier and a power supply filter are used to configure the DC/AC power conversion portion in the portion for supplying power during a power failure.

Next, embodiments of the module during a power failure of the present invention will be described in detail, based on the drawings.

### DETAILED DESCRIPTION OF THE EXEMPLARY EMBODIMENTS

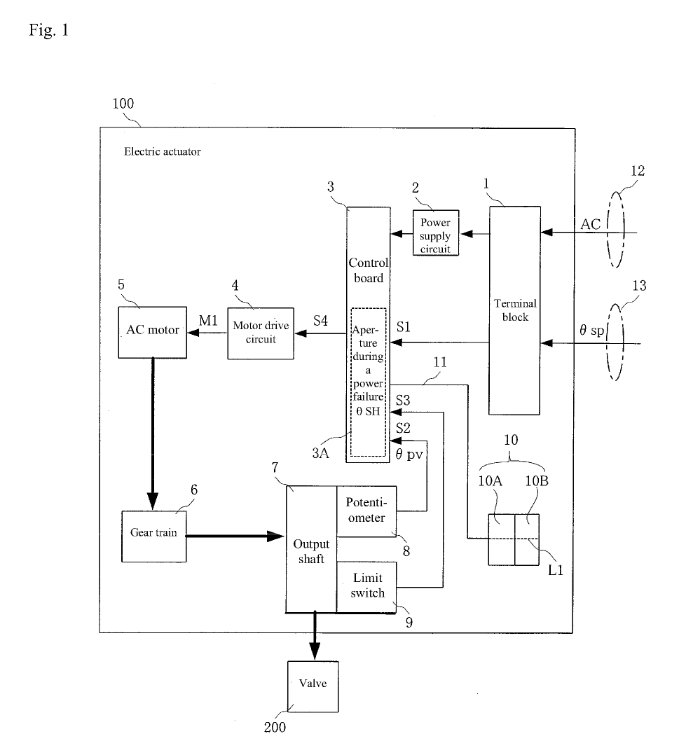

FIG. 1 is a block diagram showing the main portion of the electric actuator before connection of the module for supplying power during a power failure of the present invention. In the figure, 100 is an electric actuator, and 200 is a valve (control target) whose aperture is controlled by this electric actuator 100.

The electric actuator 100 comprises a terminal block 1, a power supply circuit 2, a control board 3, a motor drive circuit 4, an AC motor 5, a gear train 6 that transmits the driving force of the AC motor 5, an output shaft 7 that adjusts the aperture of the valve 200 as the output terminal of this gear train 6, a potentiometer 8 that detects the rotation angle position of this output shaft 7 as the actual aperture θ pv of the valve 200, and a limit switch 9 that detects the arrival at a predetermined rotation angle position of the output shaft 7.

In this electric actuator 100, the AC power AC is inputted at the terminal block 1 as the operating power supply from the exterior, and this AC power supply becomes the required internal power supply in the power supply circuit 2, after which it is supplied to the control board 3. In addition, in the terminal block 1, the set aperture θ sp is inputted as a control instruction from an air-conditioning controller (not shown), and this inputted set aperture θ sp is sent to the control board 3 as a set aperture signal S1. Also, in the control board 3, the valve 200's actual aperture θ pv from the potentiometer 8 is provided as an actual aperture detection signal S2, and the signal from the limit switch 9, which indicates arrival of the output shaft 7 at the predetermined rotation angle position, is provided as the predetermined rotation angle position arrival signal S3.

The control board 3 receives the set aperture signal S1 from the air-conditioning controller and the actual aperture detection signal S2 from the potentiometer 8, generates a control output S4 that matches the actual aperture θ pv of the valve 200 to the set aperture θ sp, and sends this generated control output S4 to the motor drive circuit 4. The motor drive circuit 4 receives the control output S4 from the control board 3, and generates a drive output signal M1 to the AC motor 5. In this control board 3, a memory 3A is provided. In this memory 3A is stored the power failure aperture θ SH, as the predetermined aperture the valve 200 is to maintain when the power fails.

The relay connector 10 has a partitioned configuration consisting of a male-side connector 10A and a female-side connector 10B. By only connecting the female-side connector 10B to the male-side connector 10A, the signal input line 11 to the control board 3 is terminated in this connector path L1.

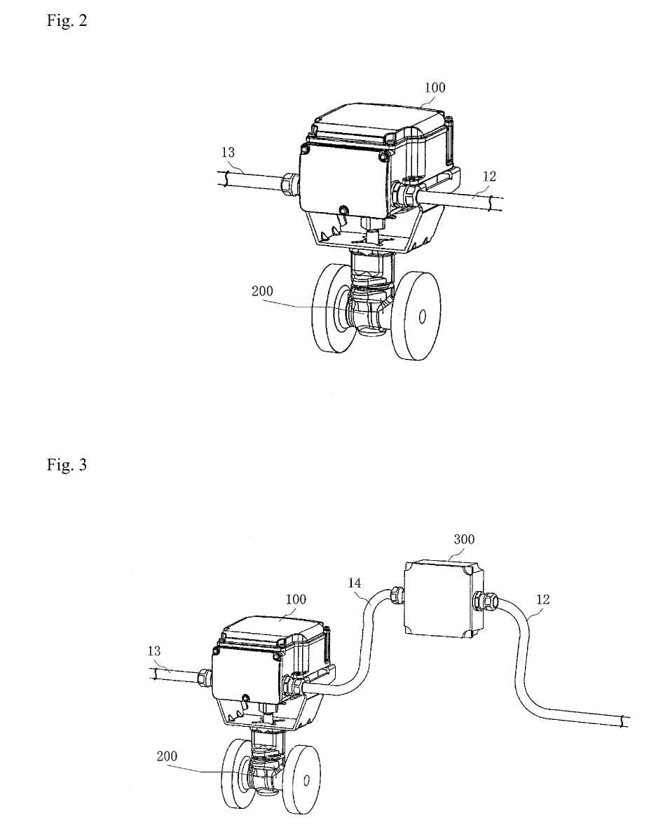

FIG. 2 is a diagram showing the appearance of this electric actuator 100. In the figure, 12 is the power line that leads the AC power supply into the interior of the electric actuator 100, and 13 is the signal line that leads the set aperture θ sp into the interior of the electric actuator 100.

In this electric actuator 100, the drive output signal M1 generated by the motor drive circuit 4 is sent to the AC motor 5, and control is performed so as to match the actual aperture θ pv of the valve 200 to the set aperture θ sp. In this manner, this electric actuator 100 functions as the ordinary electric actuator.

(When it is Used as an Electric Actuator Having an Emergency Shutoff Function)

When it is desired to use this electric actuator 100 as an electric actuator having an emergency shutoff function, as shown in FIG. 3, a module 300 for supplying power during a power failure is connected between the electric actuator 100 and the power line 12, via a cable 14.

That is, the power line 12 is detached from the electric actuator 100, this power line 12 is connected to the input side of the module 300, and the cable 14 is used to connect the output side of the module 300 and the input side of the electric actuator 100.

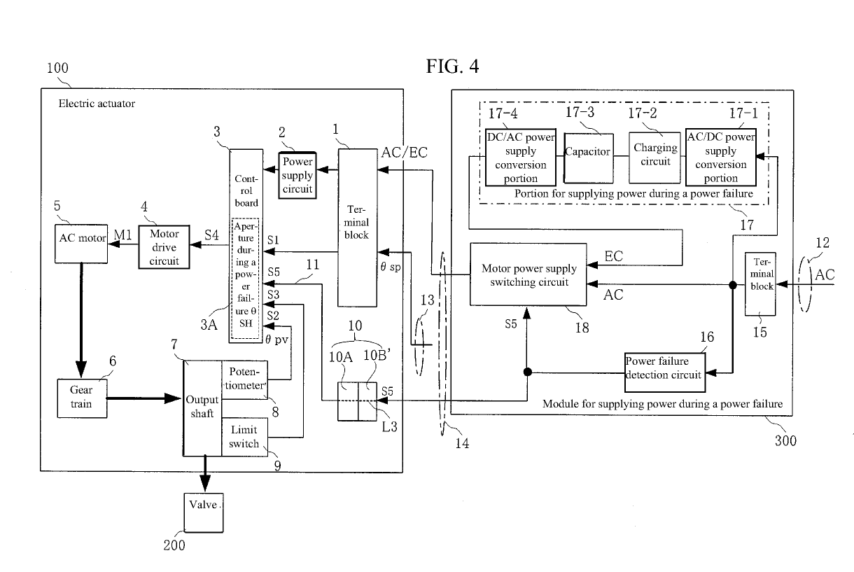

FIG. 4 is a block diagram of the main portion when the module 300 is connected to the electric actuator 100. The module 300 is one embodiment of the power failure module of the present invention, and it comprises a terminal block 15, a power failure detection circuit 16, a portion for supplying power during a power failure 17, and a motor power supply switching circuit 18.

When this module 300 is connected to the electric actuator 100, the female-side connector 10B (FIG. 1) of the relay connector 10 is detached in the electric actuator 100, and the female-side connector 10B′ led out from the power failure detection circuit 16 of the module 300 is connected to the male-side connector 10A.

In addition, in the module 300, a power line 12 is connected to the terminal block 15, and the AC power supply relayed by this terminal block 15 is sent to the motor power supply switching circuit 18.

Moreover, in the present example, the female-side connector 10B is detached, but similar wiring is obtainable by using the female-side connector 10B.

In the module 300, the power failure detection circuit 16 monitors the AC power supply relayed by the terminal block 15, and outputs the power failure detection yes/no signal S5, which notifies of the presence/absence of a power failure in the AC power supply supplied to the electric actuator 100.

The portion 17 for supplying power during a power failure comprises an AC/DC power supply conversion portion 17-1 that converts to DC power the branching input, with the AC power supply relayed by the terminal block 15 as the branching input; a charging circuit 17-2 that operates after receiving the DC power supply converted by the AC/DC power supply conversion portion 17-1; a capacitor (electric double-layer capacitor or lithium ion capacitor) 17-3 charged by this charging circuit 17-2; and a DC/AC power supply conversion portion 17-4 that generates the AC power by using the charge stored in the capacitor 17-3, and outputs it as the secondary power EC. Furthermore, an inverter is used as the DC/AC power supply conversion portion 17-4.

With the AC power supply sent from the terminal block 15 and the secondary power EC sent by the portion 17 for supplying power during a power failure as inputs, and based on the power failure detection yes/no signal S5 from the power failure detection circuit 16, the motor power supply switching circuit 18 selects the AC power supply sent from the terminal block 15 as the AC power supplied to the electric actuator 100 when the power failure detection circuit 16 does not detect failure of the AC power supply; and selects the secondary power EC sent from the portion 17 for supplying power during a power failure as the AC power supplied to the electric actuator 100 when the power failure detection circuit 16 detects failure of the AC power supply.

In this case, the cable 14 that connects the module 300 and the electric actuator 100 comprises: a line for connection to the female-side connector 10B′, which is led out from the power failure detection circuit 16, and the relay lines for the secondary power EC and the AC power supply, which are sent selectively from the motor power supply switching circuit 18.

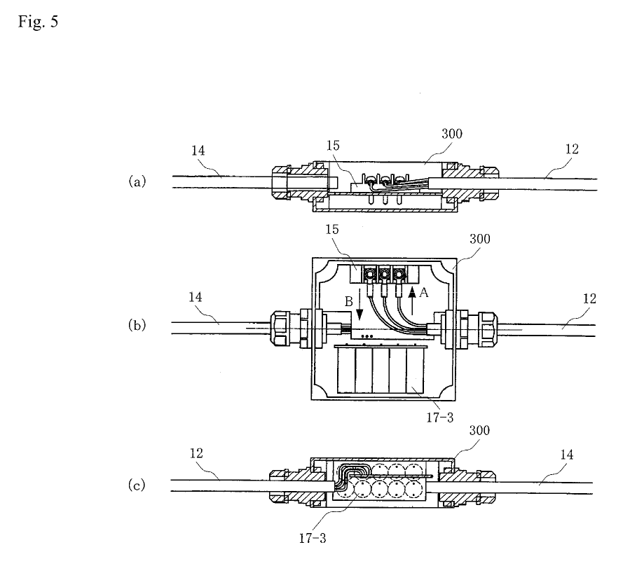

FIG. 5 shows the configuration of the interior of the module 300. FIG. 5(b) is a diagram showing the interior after opening the cover of the module 300. FIG. 5(a) is a diagram of the terminal block 15 side in FIG. 5(b), as viewed in direction A. FIG. 5(c) is a diagram of the capacitor 17-3 side in FIG. 5(b), as viewed in direction B. A plurality of capacitors (electric double-layer capacitors, lithium ion capacitors) 17-3 are provided in the module 300, to ensure high-capacity power supply during a power failure.

(When the Power does not Fail)

When the AC power supply to the electric actuator 100 does not fail, the motor power supply switching circuit 18 in the module 300 selects, as the AC power supplied to the electric actuator 100, the AC power supply sent from the terminal block 15, based on the power failure detection yes/no signal S5 from the power failure detection circuit 16. This selected AC power supply from the motor power supply switching circuit 18 is sent to the terminal block 1 of the electric actuator 100.

As a result, when the AC power supply to the electric actuator 100 does not fail, the drive output signal M1 from the motor drive circuit 4 is generated in the electric actuator 100, with the AC power supply as the energy source. Furthermore, after a power failure is determined based on the power failure detection yes/no signal S5, control is performed to match the actual aperture θ pv of the valve 200, to the set aperture θ sp.

(When the Power Fails)

When the AC power supply to the electric actuator 100 fails, the motor power supply switching circuit 18 in the module 300 selects, as the AC power supplied to the electric actuator 100, the secondary power EC from the portion 17 for supplying power during a power failure, based on the power failure detection yes/no signal S5 from the power failure detection circuit 16. The selected power supply during a power failure EC from the motor power supply switching circuit 18 is sent to the terminal block 1 of the electric actuator 100.

In addition, the power failure detection yes/no signal S5 from the power failure detection circuit 16 is sent to the control board 3 of the electric actuator 100, via the relay connector 10 (connector path L1), thereby notifying the control board 3 of the failure of the AC power supply to the electric actuator 100.

After being notified from the module 300 of the failure of the AC power supply, the control board 3 of the electric actuator 100 reads the aperture during power failure θ SH from the memory 3A, and control is performed to match the actual aperture θ pv of the valve 200 to the aperture during power failure θ SH. In this case, the drive output signal M1 from the motor drive circuit 4 is generated with the secondary power EC, which is sent from the module 300 as the energy source.

Furthermore, in the present example, the configuration is such that, after notification is received from the module 300 of the fact that the AC power supply has failed, the aperture during power failure θ SH is read from the memory 3A. Based on the predetermined rotation angle position arrival signal S3 from the limit switch 9, which indicates arrival of the output shaft 7 at the predetermined rotation angle position, the AC motor 5 may be driven until generation of this predetermined rotation angle position arrival signal S3 is confirmed. That is, if it is assumed that the predetermined rotation angle position arrival signal S3 from the limit switch 9 is a signal that indicates detection of arrival at the fully closed position of the valve 200, it is possible to perform an emergency shutoff when the AC power supply fails, by driving the AC motor 5 until generation of this predetermined rotation angle position arrival signal S3 is confirmed. In this case, it is unnecessary to set the aperture during power failure θ SH, and storage of the aperture during power failure θ SH in the memory 3A can be omitted.

(When Power is Restored)

In the module 300, monitoring of the AC power supply in the power failure detection circuit 16 continues even after the AC power supply fails. When AC power supply is restored, the power failure detection circuit 16 notifies the motor power supply switching circuit 18 of the fact, by using the power failure detection yes/no signal S5.

When notified by the power failure detection circuit 16 of the fact that AC power supply has been restored, the motor power supply switching circuit 18 selects the AC power supply sent from the terminal block 15, as the AC power supplied to the electric actuator 100. The selected AC power supply is sent from the motor power supply switching circuit 18, to the terminal block 1 of the electric actuator 100.

In addition, the power failure detection yes/no signal S5 from the power failure detection circuit 16 is sent to the control board 3 of the electric actuator 100, via the relay connector 10 (connector path L1), thereby notifying the control board 3 that the AC power supply has been restored.

After being notified that the AC power supply from the module 300 has been restored, the control board 3 of the electric actuator 100 controls so as to match the actual aperture θ pv of the valve 200 to the set aperture θ sp, as before the power failed. In this case, the drive output signal M1 from the motor drive circuit 4 is generated, with the AC power supply sent from the module 300 as the energy source.

Thus, when the module 300 is connected to the electric actuator 100, the electric actuator 100, which had until then functioned as an ordinary actuator, begins to function as an electric actuator having an emergency shutoff function.

In this electric actuator 100, the terminal block 1 corresponds to the input portion of the AC power supply of the present invention; the control board 3 corresponds to the control means; the motor drive circuit 4 corresponds to the drive output signal generation means; the AC motor 5 corresponds to the AC motor; and the potentiometer 8 corresponds to the actual aperture detection means. In addition, in the module 300, the terminal block 15 corresponds to the AC power supply relay means of the present invention; the power failure detection circuit 16 corresponds to the power failure detection means; the portion 17 for supplying power during a power failure corresponds to the means of supplying power during a power failure; the motor power supply switching circuit 18 corresponds to the power supply selection supply means.

As aforementioned, according to the module 300 of the present embodiment, when it is not connected to electric actuator 100, it causes the electric actuator 100 to function as an ordinary electric actuator; and when it is connected to the electric actuator 100, it causes the electric actuator 100 to function as an electric actuator having an emergency shutoff function.

In this case, the power line 12 and the cable 13 must be connected, but the electric actuator 100 need not be remodeled; and by either connecting or not connecting the module 300, it is possible to use an electric actuator 100 having the same configuration either as an ordinary electric actuator or as an electric actuator having an emergency shutoff function.

As a result, manufacturers need not produce two types of electric actuators. In addition, it becomes possible to simply change on site from an ordinary electric actuator to an electric actuator having an emergency shutoff function.

Also, in this example, the electric actuator 100 becomes the secondary power supply drive type. Therefore, it becomes unnecessary to increase drive motor capacity and strengthen gears for the amount of absent biasing force of the return spring, compared with the spring return type. In addition, the existing wiring layout need not be changed, so the power line 12 and the signal line 13 can be used as they are. Moreover, the module 300 can be positioned at an arbitrary position, so it becomes possible to change the electric actuator 100 to an electric actuator having an emergency shutoff function, even in a confined space.

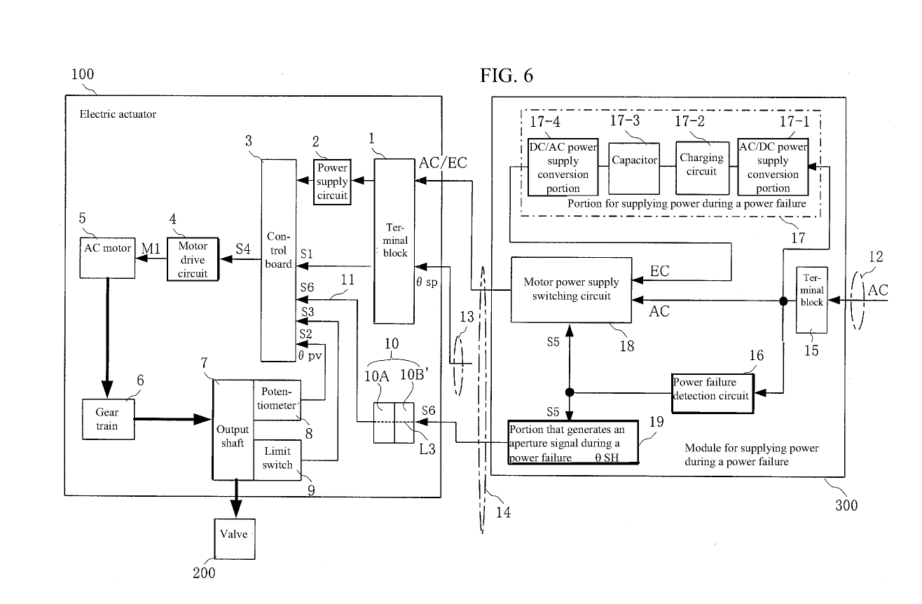

In the first embodiment described above, the configuration is such that, when the module 300 is connected to the electric actuator 100, the power failure detection yes/no signal S5 is sent from the module 300 to the electric actuator 100. However, the aperture during power failure θ SH may be used for notification, instead of the power failure detection yes/no signal S5. FIG. 6 shows the example of the use of the aperture during power failure θ SH to notify from the module 300 to the electric actuator 100, as the second embodiment.

In this second embodiment, a portion that generates an aperture signal during a power failure 19 is provided in the module 300. The configuration is such that the power failure aperture signal S6, which indicates the aperture during a power failure θ SH, is sent from this portion that generates an aperture signal during a power failure 19 to the control board 3 of the electric actuator 100, via the relay connector 10 (connector path L1).

In this case, based on the power failure detection yes/no signal S5 from the power failure detection circuit 16, when failure of the AC power supply is detected, the portion that generates an aperture signal during a power failure 19 sends the power failure aperture signal S6 to the control board 3. After receiving this power failure aperture signal S6, the control board 3 controls so as to match the actual aperture θ pv of the valve 200, to the aperture during a power failure θ SH.

In the present second embodiment, the aperture during a power failure θ SH is sent from the module 300, to the control board 3 of the electric actuator 100, so the aperture during a power failure θ SH need not to be pre-stored on the control board 3 side.

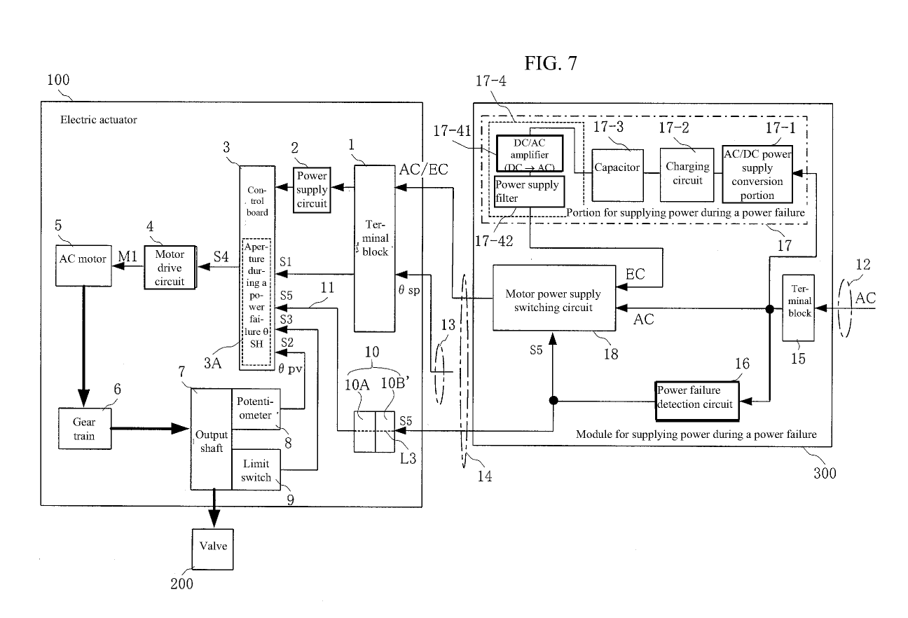

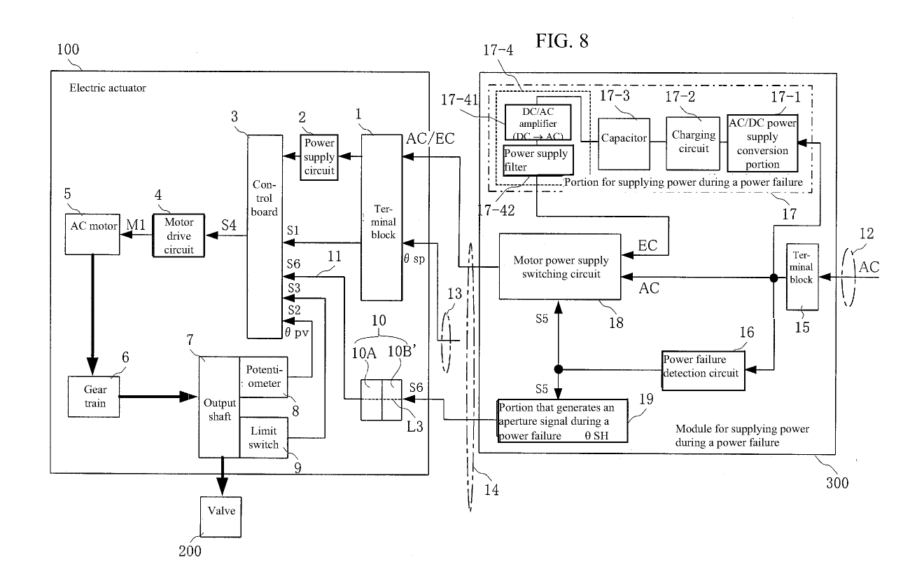

Furthermore, in the aforementioned Embodiments 1 and 2, the configuration in the portion 17 for supplying power during a power failure is such that an inverter is used as the DC/AC power supply conversion portion 17-4, in the portion for supplying power during a power failure. As shown in FIGS. 7 and 8, however, the DC/AC power supply conversion portion 17-4 may comprise a class D amplifier (DC→AC) 17-41 and a power supply filter 17-42, or may comprise an AC power amplifier.

Furthermore, in the aforementioned example, the portion 17 for supplying power during a power failure in the module 300 is configured by using a capacitor (electric double-layer capacitor, lithium ion capacitor). However, a lithium battery or other secondary battery may also be used, and a primary battery may also be used. Thus, various devices such as a non-rechargeable battery (e.g., primary battery), a rechargeable battery (e.g., secondary battery), electric double-layer capacitor, etc., can be used as the means of generating the secondary power EC, and they may be used by selecting appropriately.

### INDUSTRIAL APPLICABILITY

The module for supplying power during a power failure of the present invention may be used in various fields, such as air-conditioning equipment, as a module for supplying power during a power failure that is connected to an electric actuator that controls a flow by adjusting the aperture of a control target, such as a valve, damper, etc.

### DESCRIPTION OF THE SYMBOLS

1 Terminal block, 2 Power supply circuit, 3 Control board, 3A Memory, 4 Motor drive circuit, 5 AC motor, 6 Gear train, 7 Output shaft, 8 Potentiometer, 9 Limit switch, 10 Relay connector, 10A Male-side connector, 10B, 10B′ Female-side connector, L1 Connector path, 11 Signal input line, 12 Power line, 13 Signal line, 14 Cable, 15 Terminal block, 16 Power failure detection circuit, 17 Portion for supplying power during a power failure, 17-1 AC/DC power supply conversion portion, 17-2 Charging circuit, 17-3 Capacitor (e.g., electric double-layer capacitor, lithium ion capacitor), 17-4 DC/AC power supply conversion portion, 17-41 Class D amplifier, 17-42 Power supply filter, 18 Motor power supply switching circuit, 19 Portion that generates an aperture signal during a power failure, 100 Electric actuator, 200 Valve, 300 Module for supplying power during a power failure.

What is claimed is:

1. An electric actuator, comprising:
a rotatable shaft responsive to a first signal; and
a memory that stores a specified position for the rotatable shaft when primary power is removed from the electric actuator;
wherein the electric actuator receives a second signal generated outside the electric actuator to indicate whether the primary power is removed.

2. The electric actuator of claim 1, wherein, when the second signal indicates that the primary power is removed from the electric actuator, the first signal is based at least in part on the specified position for the rotatable shaft that is stored in the memory.

3. The electric actuator of claim 2, wherein the electric actuator further comprises a motor coupled to the rotatable shaft, the motor being responsive to the first signal to adjust a position of the rotatable shaft to the specified position that is stored in the memory.

4. The electric actuator of claim 1, wherein the electric actuator is configured to receive secondary power externally.

5. The electric actuator of claim 4, wherein the primary power and the secondary power are of the same type.

6. The electric actuator of claim 5, wherein each of the primary power and the secondary power are alternating current power.

7. The electric actuator of claim 2, further comprising a device coupled to the rotatable shaft, the device detecting a position of the rotatable shaft.

8. The electric actuator of claim 7, wherein the device generates a position signal indicating the position of the rotatable shaft.

9. The electric actuator of claim 8, wherein the first signal is generated based at least in part on the position signal.

10. The electric actuator of claim 9, wherein the device comprises a potentiometer.

11. The electric actuator of claim 7, wherein the device generates an arrival signal indicating that the rotatable shaft has arrived at a predetermined position.

12. The electric actuator of claim 11, wherein the first signal is generated based at least in part on the arrival signal.

13. The electric actuator of claim 12, wherein the device comprises a limit switch.

14. An electric actuator comprising a rotatable shaft that is responsive to a first signal, wherein the electric actuator receives a second signal that is generated outside of the electric actuator and specifies a position for the rotatable shaft when primary power is removed from the electric actuator.

15. The electric actuator of claim 14, wherein, when the primary power is removed from the electric actuator, the first signal is generated based at least in part on the second signal.

16. The electric actuator of claim 15, wherein the electric actuator further comprises a motor coupled to the rotatable shaft, the motor being responsive to the first signal to adjust a position of the rotatable shaft to the position that is specified by the second signal.

17. The electric actuator of claim 16, wherein the electric actuator is configured to receive secondary power externally.

18. The electric actuator of claim 17, wherein the primary power and the secondary power are of the same type.

19. The electric actuator of claim 18, wherein each of the primary power and the secondary power source are alternating current power.

20. The electric actuator of claim 15, further comprising a device coupled to the rotatable shaft, the device detecting a position of the rotatable shaft.

21. The electric actuator of claim 20, wherein the device generates a position signal indicating the position of the rotatable shaft.

22. The electric actuator of claim 21, wherein the first signal is generated based at least in part on the position signal.

23. The electric actuator of claim 22, wherein the device comprises a potentiometer.

24. The electric actuator of claim 20, wherein the device generates an arrival signal indicating that the rotatable shaft has arrived at a predetermined position.

25. The electric actuator of claim 24, wherein the first signal is generated based at least in part on the arrival signal.

26. The electric actuator of claim 25, wherein the device comprises a limit switch.

27. A module for supplying power to an electric actuator, comprising:
a detection circuit generating a signal indicating whether primary power is being supplied to the module;
a power supply storing primary power supplied to the electric actuator, the power supply providing secondary power of a similar type as the primary power; and
a switching circuit outputting, in response to the signal, one of the primary power or the secondary power.

28. The module of claim 27, wherein the module is configured to provide the output of the switching circuit external to the module.

29. The module of claim 27, wherein the module is configured to provide the signal external to the module.

30. The module of claim 27, wherein each of the primary power and the secondary power are alternating current power.

31. A module for supplying power to an electric actuator, comprising:
a detection circuit generating a first signal indicating whether primary power is being supplied to the module;
a power supply storing primary power supplied to the module, the power supply providing secondary power of a similar type as the primary power; and
a switching circuit outputting, in response to the first signal, one of the primary power or the secondary power;
wherein the module generates, in response to the first signal, a second signal that specifies an output for the electric actuator when primary power is removed from the electric actuator.

32. The module of claim 31, wherein the module is configured to provide the output of the switching circuit external to the module.

33. The module of claim 31, wherein the module is configured to provide the second signal external to the module.

34. The module of claim 31, wherein each of the primary power and the secondary power are alternating current power.

35. An electric actuator system, comprising:
an electric actuator; and
a module detachably connected to the electric actuator;
wherein the electric actuator comprises a rotatable shaft responsive to a first signal that is generated based at least in part on a second signal received from outside the electric actuator.

36. The electric actuator system of claim 35, wherein the second signal indicates whether primary power is being supplied to the module.

37. The electric actuator system of claim 36, wherein the module comprises:
a detection circuit generating the second signal;
a power supply storing primary power supplied to the electric actuator, the power supply providing secondary power of a similar type as the primary power when the primary power is removed from the module; and
a switching circuit outputting, in response to the second signal, one of the primary power or the secondary power.

38. The electric actuator system of claim 35, wherein the second signal specifies a position for the rotatable shaft when primary power is removed from the electric actuator.

39. The electric actuator system of claim 38, wherein the module comprises:
a detection circuit generating a third signal indicating whether primary power is being supplied to the module;
a power supply storing primary power supplied to the electric actuator, the power supply providing secondary power of the similar type as the primary power; and
a switching circuit outputting one of the primary power or the secondary power in response to the third signal.

40. The electric actuator system of claim 39, wherein the second signal is generated in response to the third signal.

41. The electric actuator system of claim 35, wherein the electric actuator further comprises a device coupled to the rotatable shaft, the device detecting a position of the rotatable shaft.

42. The electric actuator system of claim 41, wherein the device generates a position signal indicating the position of the rotatable shaft.

43. The electric actuator system of claim 42, wherein the first signal is generated based at least in part on the position signal.

44. The electric actuator system of claim 41, wherein the device generates an arrival signal indicating that the rotatable shaft has arrived at a predetermined position.

45. The electric actuator system of claim 44, wherein the first signal is generated based at least in part on the arrival signal.

46. A method for providing an electric actuator with a shutoff function, the method comprising the steps of:
deriving secondary power for the electric actuator from primary power for the electric actuator, the secondary power being of a similar type as the primary power;
detecting whether primary power is available to the electric actuator, the detecting step being performed external to the electric actuator;
providing the primary power to the electric actuator when the detecting step indicates that primary power is available to the electric actuator; and
providing the secondary power to the electric actuator when the detecting step indicates that primary power is not available to the electric actuator.

47. The method of claim 46, wherein each of the primary power and the secondary power are alternating current power.

48. The method of claim 47, wherein the deriving step comprises:
converting the primary power from alternating current power to direct current power;
storing the direct current power; and
converting the direct current power to alternating current power.

49. A method for providing an electric actuator with a shutoff function, the method comprising the steps of:
generating a first signal external to the actuator;
supplying the first signal to the electric actuator; and
generating a second signal internal to the electric actuator based at least in part on the first signal.

50. The method of claim 49, wherein the first signal indicates whether primary power is available to the electric actuator.

51. The method of claim 50, wherein:
the electric actuator comprises a rotatable shaft; and
the method further comprises the steps of:
providing the electric actuator with a memory;
storing in the memory a specified position for the rotatable shaft when primary power is not available to the electric actuator; and
generating the second signal in such a way that the position of the rotatable shaft is adjusted to the specified position.

52. The method of claim 51, further comprising the step of determining when the rotatable shaft has reached the specified position.

53. The method of claim 51, wherein the first signal specifies a position for the rotatable shaft when primary power is not available to the electric actuator.

54. The method of claim 53, further comprising the step of determining when the rotatable shaft has reached the specified position.
